(19) United States
(12) Patent Application Publication
(10) Pub. No.: US 2009/0189421 A1
(43) Pub. Date: Jul. 30, 2009

(54) Saddle Assembly and Venting Device Thereof

(75) Inventors: Tsai-Yun Yu, Taichung Hsien (TW); Wei-Min Huang, Banqiao City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: INTERNATIONAL BICYCLE PRODUCTS CORPORATION, Tachia (TW)

(21) Appl. No.: 12/126,305

(22) Filed: May 23, 2008

(30) Foreign Application Priority Data
Jan. 30, 2008 (TW) 097103453
Apr. 24, 2008 (TW) 097115042

(51) Int. Cl. B62J 1/00

(52) U.S. Cl. 297/195.1

(57) ABSTRACT

A saddle assembly and a venting device thereof are provided. The venting device comprises a body and an air-passage structure, wherein the body has an upper surface and a peripheral portion, while the air-passage structure is at least partially formed on the upper surface and connects at least one portion of the peripheral portion. The venting device is preferably made of a shock-absorbing material, so that the venting device and the saddle assembly are heat dissipative and shock-absorbing.

This application claims priority to Taiwan Patent Application No. 097103453 filed on Jan. 30, 2008 and Taiwan Patent Application No. 097115042 filed on Apr. 24, 2008.

### CROSS-REFERENCES TO RELATED APPLICATIONS

Not applicable.

### BACKGROUND OF THE INVENTION

1. Field of the Invention

The present invention relates to a venting device, and more particularly, relates to a venting device of a saddle assembly and the saddle assembly comprising the venting device.

2. Descriptions of the Related Art

Bicycles have become more of a means for recreation and physical exercise, rather than merely for transportation. As a result, the demands on the bicycle have increased accordingly. Aside from the weight and the profile of the bicycle, the comfort of the saddle has also become an important purchasing factor. The two most important factors that determine the quality of the saddle are the ventilation and cushioning capability against various external forces during the ride. These two factors improve the comfort and health of the cyclist, regardless of the gender. Furthermore, these are also the two factors on which saddle designers seek to improve sport apparatuses (for example but not limited to bicycles) used for various purposes (racing, recreation, children playing).

To provide the desired cushioning effect, a conventional saddle 1 as depicted in FIG. 1 comprises a crotch portion 11, a buttock portion 12, an air bag 13 and a rail 14. The saddle 1 interfaces with the body of the bicycle via the rail 14, and the buttocks of the cyclist seat on the buttock portion 12 during the ride. By disposing the air bag 13 in the buttock portion 12, the saddle 1 provides an adequate cushioning capability. Unfortunately, the saddle 1 fails to provide adequate ventilation, causing a stuffy and damp feeling in the crotch area. This makes it difficult for the cyclist to ride a bicycle for an extended period of time and also pose a threat to the health of the cyclist.

In view of this, it is highly desirable in the field to provide a saddle assembly with favorable cushioning capability and ventilation effect, as well as a venting device thereof.

### SUMMARY OF THE INVENTION

One objective of this invention is to provide a saddle assembly and a venting device thereof with a favorable ventilation effect and cushioning capability.

This invention provides innovative research and design on the venting device of a saddle assembly. The venting device comprises a body and an air-passage structure. The body has an upper surface and a peripheral portion. The air-passage structure is at least partially formed on the upper surface and in fluid communication with at least one portion of the peripheral portion. The venting device may be optionally (but not limited to) made of a shock-absorbing material. The saddle assembly of this invention at least comprises the venting device, a pad device and a fastening device, which may be entirely or partially formed integrally. The pad device is disposed on the venting device, and the fastening device is disposed between the venting device and the pad device to fasten the pad device on the venting device.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional saddle;

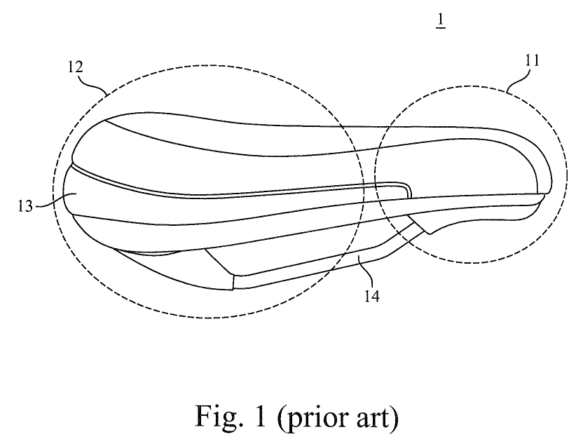

FIG. 2 is a side assembled view of a saddle assembly of this invention;

FIG. 3 is a top view of a venting device of this invention;

FIG. 4 is an exploded top view of a saddle assembly of this invention;

FIG. 5 is an exploded bottom view of a saddle assembly of this invention;

FIG. 6 is a side cross-sectional exploded view of a saddle assembly of this invention; and

FIG. 7 is a side cross-sectional assembled view of a saddle assembly of this invention.

### DESCRIPTION OF THE PREFERRED EMBODIMENT

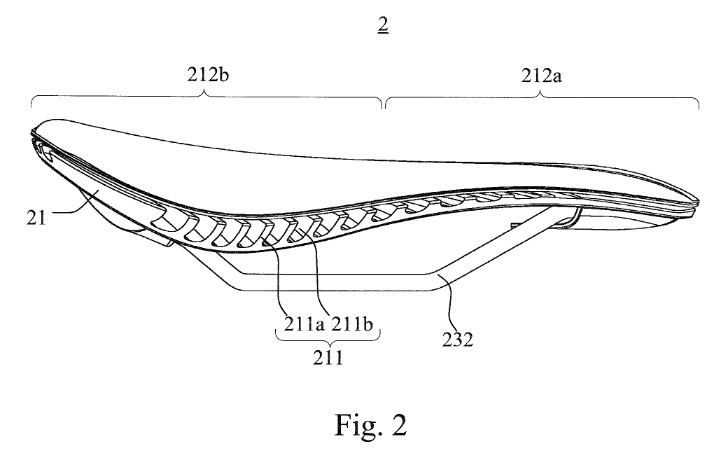

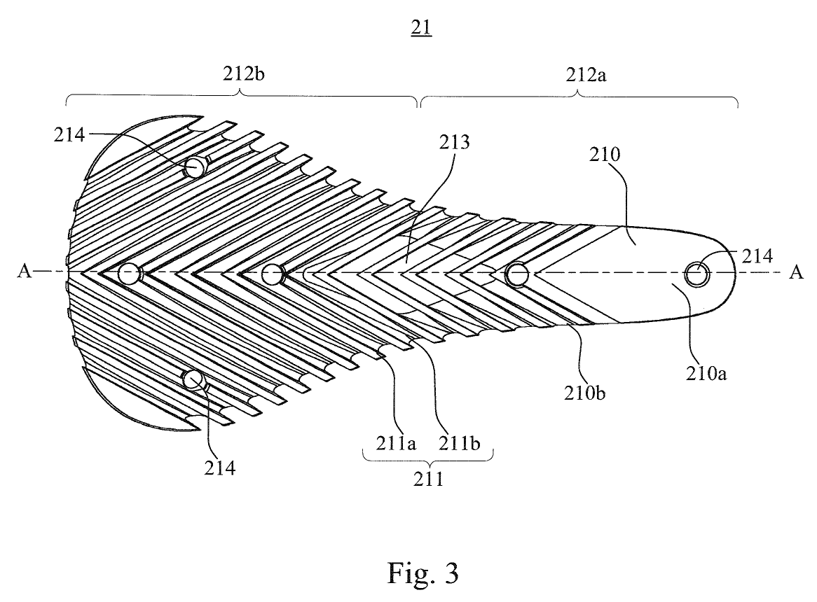

As depicted in FIG. 2, a saddle assembly 2 of this invention has a venting device 21 disposed therein. By disposing an air-passage structure 211, the saddle structure 2 has a favorable ventilation and cushioning capability. FIG. 3 depicts the detailed structure of the venting device 21, which comprises a body 210 and an air-passage structure 211. The body 210, which has substantially a same profile as the saddle assembly 2, comprises a crotch portion 212a and a buttock portion 212b at a rear portion of the crotch portion 212a. The air-passage structure 211 is at least partially formed on a top surface 210a of the body 210 and in fluid connection with at least one portion of a peripheral portion 210b of the body 210. Moreover, the air-passage structure 211 is configured to cover at least one portion of the buttock portion 212b and the crotch portion 212a. In this way, the ambient air is allowed to flow from the peripheral portion 210b through the air-passage structure 211 into the saddle assembly 2.

Preferably, the air-passage structure 211 comprises a plurality of ribs 211a. The plurality of ribs 211a are substantially parallel to and extend upwards from the top surface 210a of the body 210 to correspondingly form the plurality of air passages 211b, so that ambient air is allowed to flow from the peripheral portion 210b through the air passages 211b into the saddle assembly 2. Each of the ribs 211a substantially extends to the peripheral portion 210b symmetrically with respect to a center line A of the body 210 to form V-shape configurations with the angles pointed towards the rear of the saddle assembly 2 to force the ambient air to flow backwards into the saddle assembly 2 from the front during the ride. Furthermore, the venting device 21 is preferably made of a shock-absorbing material that is moderately elastically deformable to provide the venting device 21 with a desirable cushioning capability by virtue of deformation of the ribs 211a during the ride. The elastic deformation of the ribs 211a tends to change the shape and volume of the air passages 211b between the ribs 211a and forces the air to flow more smoothly inside the air passages 211b, thus enhancing the venting performance of the venting device 21.

It should be noted that since the shock-absorbing material for the venting device 21 may be either used alone or combined with other materials at the top or bottom to enhance the cushioning effect, materials with a soft or hard touching sense may be adopted in practice. In particular, this material may be selected from the group consisting of foam materials (optionally, either partially or completely foamed), Silica Gel, Ethylene-vinyl Acetate (EVA), Poly Urethane (PU), Thermo Plastic Rubber (TPR) and the combination thereof, any of which may provide the air-passage structure with the appropriate hardness and elasticity and provide necessary support, shock absorption and heat dissipation.

As depicted in FIG. 3, the body 210 further comprises at least one through-hole 213 for fluidly connecting an upside and a downside of the body 210. The at least one through-hole 213 is at least formed in the crotch portion 212a to allow air to flow in the air passages 211b as well as the upside and the downside of the body 210 to enhance the ventilation of the saddle assembly 2 as a whole. If the saddle assembly 2 is comprised of a plurality of elements in combination, the body 210 may comprise a plurality of connecting holes 214 for fastening the venting device 21 with peripheral elements to construct the saddle assembly 2.

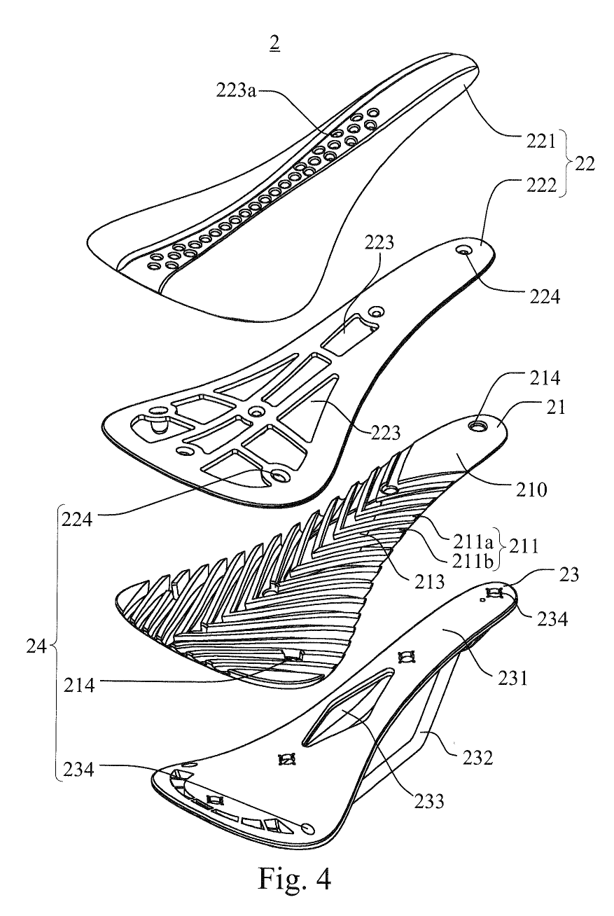

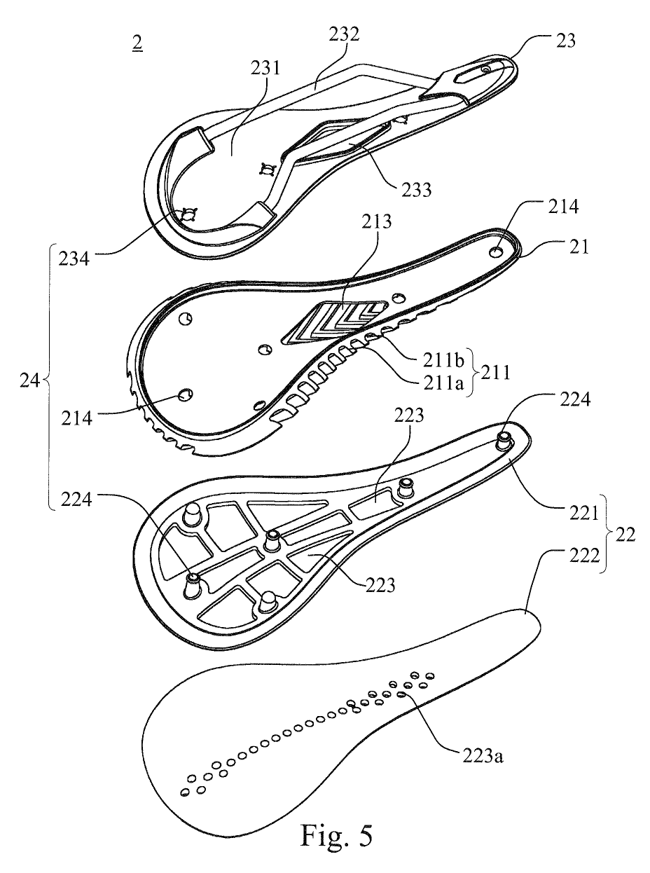

As shown in FIGS. 4 and 5, the saddle assembly 2 of this embodiment consists of a plurality of elements, including the venting device 21, a pad device 22, a supporting device 23, and a fastening device 24 interposed therebetween for fastening these elements with each other.

The supporting device 23 is disposed under the venting device 21 and has substantially the same profile as the body 210. The supporting device 23 is primarily comprised of a base 231 and includes a rail device 232 fastened to a lower surface of the base 231. The rail device 232 is adapted to interface with the body of the bicycle to fasten the saddle assembly 2 on the bicycle body. The base 231 may be made of a plastic material with a certain strength or a carbon fiber reinforced material.

The pad device 22, which is disposed on the venting device 21, provides an ergonomic surface for properly supporting the buttocks and crotches of the cyclists. In this embodiment, the pad device 22 comprises a foam layer 221 and a fastening layer 222, all with substantially the same profile as the body 210 of the venting device 21. The fastening layer 222 is fixedly disposed under the foam layer 221, while a male connecting device 224 extends downwards from the fastening layer 222. The fastening layer 222 has at least one hollowed portion 223. The foam layer 221 may have a plurality of fine pores 223a. With such an arrangement, air is allowed to flow through the plurality of air passages 211b of the venting device 21, the hollowed portion 223 of the fastening layer 222, the foam layer 221, and the fine pores 223a of the foam layer 221 to an upside of the saddle assembly 2. The foam layer 221 and the fastening layer 222 are enclosed and fastened by a breathable layer (not shown) disposed on the foam layer 221 to form a complete pad device 22 which allows comfortable riding over a long period of time and provides adequate support. The fastening layer 222 may be made of various plastic materials or carbon fiber reinforced materials to provide adequate support, while the breathable layer may be made of various textiles, breathable leathers or other breathable materials to provide an appropriate heat dissipation passage directed upwards.

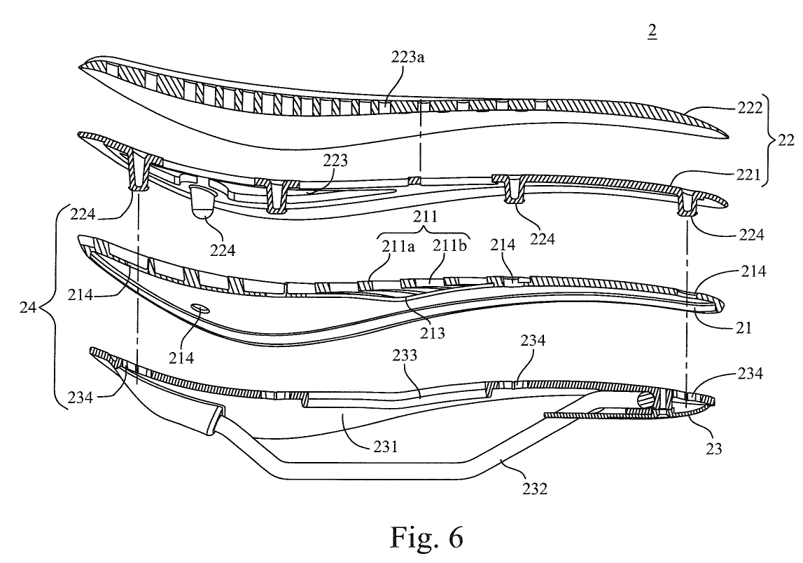

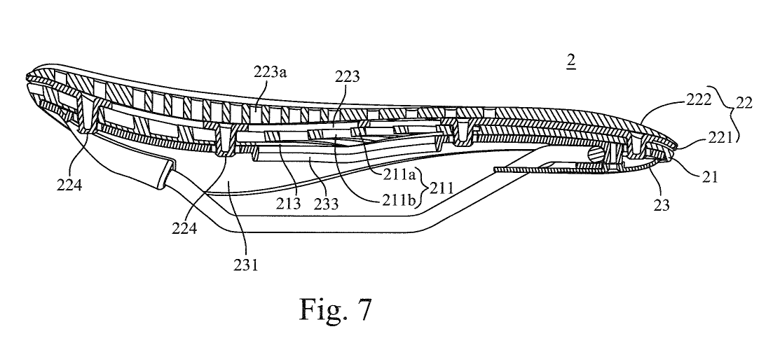

As shown in both FIGS. 6 and 7, the fastening device 24 is disposed between the venting device 21 and the pad device 22 to fasten the pad device 22 on the venting device 21 and further fasten the base of the supporting device 23 under the venting device 21. In this embodiment, the fastening device 24 comprises a male connecting device 224 and a female connecting device. The male connecting device 224 extends downwards from the pad device 22, while the female connecting device comprises a plurality of connecting holes 214, 234 correspondingly formed on the venting device 21 and the base of the supporting device 23 for the insertion of the male connecting device 224. The male connecting device 224 of this embodiment comprises a plurality of nuts and a plurality of screws adapted to be screwed into these nuts, while the female connecting device comprises a plurality of connecting holes 214, 234 correspondingly formed on the venting devices 21 and the base 231 of the supporting device 23. In this way, by screwing the plurality of screws into the nuts through the connecting holes, the venting device 21, the pad device 22 and the supporting device 23 are fastened together. However, in other embodiments, the fastening device 24 may also fasten the venting device 21, the pad device 22 and the supporting device 23 by other permanent or detachable means such as snap fitting, riveting, gluing or hot gluing. However, these equivalent substitutions are not related to the core technology of this invention and still fall within the scope of the claims of this invention.

The air flow path inside the saddle assembly 2 will be further described. As shown in FIGS. 2, 6 and 7, air is adapted to flow from the side of the saddle assembly 2 through the air passages 211b of the air-passage structure 211, the through-hole 213, the hollowed portion 223 of the fastening layer 222, the foam layer 221 and the fine pores 223a of the foam layer 221, and then escape upwards from the breathable layer. Furthermore, the through-hole 213 in the body 210 of the venting device 21 corresponds to an opening 233 in the base 231 of the supporting device 23, so it is further adapted for air to flow from a downside of the saddle assembly 2 through the through-hole 213 of the venting device 21, the opening 233 of the supporting device 23, the hollowed portion 223 of the fastening layer 221 and the foam layer 221 and the fine pores 223a of the foam layer 221, and then escape upwards from the breathable layer. This provides the saddle assembly 2 with favorable ventilation performance, which, in combination with the elastic deformation of the shock-absorbing material forming the venting device 21, will provide adequate cushioning effect for the cyclists and further introduce dynamic deformation in the air passages 211b to force air being breathed-in and breathed-out the saddle assembly 2 of this invention. Therefore, the venting device 21 is adapted to keep the crotch and the buttocks dry and provide the rider with comfort over a long period of time.

In the above embodiment, the saddle assembly 2 of this invention is primarily comprised of the foam layer 221 of the pad device 22, the fastening layer 222 of the pad device 22, the venting device 21 and the supporting device 23. However, in other embodiments, these devices may be partially or entirely integrated together. For example, instead of being comprised of the foam layer 221 and the fastening layer 222, the pad device 22 may be formed integrally of a carbon fiber reinforced material. In this case, the pad device 22 can be assembled into the saddle assembly 2 by simply having the male connecting device 224 of the fastening device 24 correspondingly formed on the lower surface of the integrally formed pad device; and by forming a plurality of venting pores or hollowed portions in the pad device 22, the pad device 22 can cooperate with the venting device 21 and the supporting device 23 to achieve the desirable ventilation effect. Similarly, if both the venting device 21 and the base 231 of the supporting device 23 are also made of a shock-absorbing material, a single-piece device may be formed integrally. However, in order for the resulting single-piece device to have sufficient supporting ability to connect the bicycle body and support weight of the cyclist, this material may be selected from materials with both an adequate strength and an adequate cushioning capability such as poly urethane (PU) or thermal plastic rubber. In case these devices are highly integrated, the saddle assembly 2 as a whole can further be formed into a single-piece of materials also with both an adequate strength and an adequate cushioning capability such as polyurethane (PU) or thermal plastic rubber. Hence, any other saddles incorporating similar ribs 211a or air passages 211b of the air-passage structure 211 of this invention can accomplish the basic objective of favorable ventilation performance of this invention. Moreover, in case the air-passage structure 211 is made of a shock-absorbing material, a favorable cushioning capability can further be obtained. Therefore, all these embodiments shall fall within scope of the claims of this invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A venting device of a saddle assembly, comprising:
a body having an upper surface and a peripheral portion;
an air-passage structure, comprising a plurality of ribs substantially extending upward from the upper surface of the body to correspondingly form a plurality of air passages, at least partially formed on the upper surface and fluidly connecting at least one portion of the peripheral portion.

2. The venting device as claimed in claim 1, wherein the body has a substantially same profile as the saddle assembly.

3. The venting device as claimed in claim 2, wherein the body has a crotch portion and a buttock portion at a rear portion of the crotch portion, and the air-passage structure is configured to cover at least one portion of the crotch portion and the buttock portion.

4. The venting device as claimed in claim 3, wherein the ribs are substantially parallel to each other.

5. The venting device as claimed in claim 4, wherein each of the ribs substantially extends to the peripheral portion symmetrically with respect to a center line of the body to form V-shape configurations.

6. The venting device as claimed in claim 5, wherein the body and the air-passage structure are integrally made of a shock-absorbing material.

7. The venting device as claimed in claim 6, wherein the shock-absorbing material is selected from the group of foam material, Silica Gel, Ethylene-vinyl Acetate (EVA), Poly Urethane (PU), Thermo Plastic Rubber (TPR) and the combination thereof.

8. The venting device as claimed in claim 1, wherein the body comprises at least one through hole for fluidly connecting an upside and a downside of the body, and the at least one through hole is formed in a crotch portion of the body.

9. The venting device as claimed in claim 1, wherein the body comprises a plurality of connecting holes for fastening the venting device into the saddle assembly.

10. A saddle assembly, comprises:
a venting device having:
a body, having an upper surface and a peripheral portion; and
an air-passage structure, comprising a plurality of ribs substantially extending upward from the upper surface of the body to correspondingly form a plurality of air passages, at least partially formed on the upper surface and fluidly connecting at least one portion of the peripheral portion;
a pad device disposed on the venting device; and
a fastening device disposed between the venting device and the pad device to fasten the pad device on the venting device.

11. The saddle assembly as claimed in claim 10, further comprising a supporting device, disposed under the venting device and having a substantially same profile as the body.

12. The saddle assembly as claimed in claim 11, wherein the supporting device comprises a base and a rail device fastened to a lower surface of the base, and the fastening device further fastens the base under the venting device.

13. The saddle assembly as claimed in claim 12, wherein the fastening device comprises a male connecting device and a female connecting device, the male connecting device extends downward from the pad device, and the female connecting device is formed correspondingly on the venting device and the base of the supporting device for embedment of the male connecting device.

14. (canceled)

15. The saddle assembly as claimed in claim 13 wherein the pad device is integrally made of a Carbon Fiber Reinforced material.

16. The saddle assembly as claimed in claim 13 wherein the pad device comprises:
a foam layer having a substantially same profile as the body; and
a fastening layer, having a substantially same profile as the body, disposed under the foam layer, the male connecting device extending downward from the fastening layer, and the fastening layer having at least one hollowed portion;
configured for the upward dissipation of air flowing from a side of the saddle assembly through the air-passage structure, the hollowed portion of the fastening layer, and the foam layer.

17. The saddle assembly as claimed in claim 16, wherein the body of the venting device comprises at least one through hole and the base of the supporting device correspondingly comprises at least one open hole for the upward dissipation of air flowing from a downside of the saddle assembly through the at least one open hole, the at least one through hole, the hollowed portion of the fastening layer, and the foam layer.

18. (canceled)
